(19) United States
(12) Patent Application Publication
(10) Pub. No.: US 2014/0034220 A1
(43) Pub. Date: Feb. 6, 2014

(54) PROCESS AND PLANT FOR BUILDING TYRES FOR VEHICLE WHEELS

(71) Applicants: Gianni Mancini, Milano (IT); Maurizio Marchini, Milano (IT); Pietro Dale', Milano (IT); Gian Luigi Bosio, Milano (IT); Andrea Crepaldi, Milano (IT)

(72) Inventors: Gianni Mancini, Milano (IT); Maurizio Marchini, Milano (IT); Pietro Dale', Milano (IT); Gian Luigi Bosio, Milano (IT); Andrea Crepaldi, Milano (IT)

(21) Appl. No.: 14/112,718

(22) PCT Filed: Mar. 23, 2012
(86) PCT No.: PCT/IB12/51398

§ 371 Date: Oct. 18, 2013

Related U.S. Application Data
(60) Provisional application No. 61/482,720, filed on May 5, 2011.

(30) Foreign Application Priority Data
Apr. 28, 2011 (IT) MI2011A000710

(51) Int. Cl. B29D 30/24

(52) U.S. Cl. CPC B29D 30/242
USPC 156/117; 156/128.1; 156/414; 156/397

(57) ABSTRACT

During tyre building, a crown structure is built through the actions of: forming at least one belt layer on an auxiliary drum for manufacturing a belt structure at least partly; turning up axially opposite side flaps of said at least one belt layer formed on the auxiliary drum; transferring the belt structure from the auxiliary drum to at least one service drum; and forming a tread band by winding of at least one continuous elongated element of elastomeric material into coils disposed mutually adjacent around the belt structure carried by the service drum.

The present invention relates to a process and a plant for building tyres for vehicle wheels. More specifically, the invention is particularly addressed to the manufacture of ultra high performance tyres, above all for sports car races.

A tyre for vehicle wheels generally comprises a carcass structure including at least one carcass ply having respectively opposite end flaps in engagement with respective annular anchoring structures, integrated into the regions usually identified with the name of “beads”, defining the radially internal circumferential edges of the tyre.

Associated with the carcass structure is a crown structure. To the aims of the present specification and the following claims, by “crown structure” of a tyre it is intended at least one belt structure or breaker having one or more belt layers placed in radially superposed relationship relative to each other and to the carcass ply, having textile or metallic reinforcing cords in a crossed orientation and/or substantially parallel to the circumferential extension direction of the tyre. More preferably, the crown structure comprises a belt structure having at least one belt layer and a tread band of elastomeric material applied at a radially external position to the belt structure. In addition, respective sidewalls of elastomeric material are applied at an axially external position to the side surfaces of the carcass structure, each extending from one of the side edges of the tread band until close to the respective annular anchoring structure to the beads. In tyres of the “tubeless” type, an airtight coating layer usually referred to as “liner” covers the inner tyre surfaces.

The Applicant thinks it particularly useful to turn up the ends of the belt layers for performance purposes. In fact, turning up of the axially opposite flaps of a belt layer onto the belt layers radially external thereto gives the tyre more reactivity and quickness of response to the tyre during the step of getting over a bend.

Referring particularly to ultra high performance tyres, above all if intended for car races imposing hard handling conditions, the Applicant thinks it suitable to make the belt layer or layers starting from manufactured articles in the form of a strip with reinforcing cords of the textile type, the axially opposite side edges of which are turned up to at least partly cover the radially outermost belt layer.

The Applicant has however noticed that in manufacturing some tyre models it is preferred that the axially opposite flaps of one or more of the radially innermost belt layers be turned up on the radially outermost belt layer or layers, so as to inhibit the free ends of the reinforcing cords from mechanically interfering against the carcass structure thereby causing crackings that would tend to propagate and damage the tyre structure.

The Applicant has verified the possibility of manufacturing the belt structure through a process in which an annular assembly comprising a first radially internal belt layer and at least one radially external belt layer is formed on a first drum. Axially opposite end portions of the first belt layer would then be turned up onto said at least one second belt layer, so as to at least partly cause overlapping of the end portions of the first belt layer onto said at least one radially external belt layer.

Moreover, the Applicant believes that in making tyres for sports races and/or ultra high performance tyres, manufacture of the tread band by spiralling is particularly advantageous, i.e. through winding up of a continuous elongated element of raw elastomeric material so as to form coils respectively disposed adjacent to each other around the belt structure until defining the tread band consisting of one or more layers of the desired thickness and cross-section profile.

The Applicant has however perceived that turning-up carried out in making the belt structure and spiralling carried out in forming the tread band typically need rather long manufacturing times; these times, added to each other in manufacturing the crown structure, tend to reduce productivity. In addition use of relatively complicated and bulky equipment is required for these operations, which equipment can be hardly integrated into the same production unit.

In this context, the Applicant has felt the necessity to reconcile the requirement of carrying out particular operations such as turning-up and spiralling, requested in making the crown structure for the purpose of achieving excellent quality standards and maximum repeatability of results in the final product, with the requirement of obtaining high exploitation of the equipment and efficient limitation of the processing down time, to the benefit of the production efficiency.

The Applicant has perceived that if provision is made for the simultaneous execution of different process actions during manufacture of the crown structures intended for respective tyres under production, it is possible to optimise the time required for execution of each of said process actions, in harmony with the time required for building the carcass structure and coupling it to the crown structure itself.

The Applicant has therefore found that by providing, within the area of the crown structure building, turning-up operations for one or more belt layers and spiralling operations for the tread band during which said belt layers are transferred onto a service drum where building of said tread band is continued, processing of the different crown structures appears to be divided, to the benefit of the qualitative features of the final product, without productivity being damaged.

In greater detail, in accordance with a first aspect, the invention relates to a process for tyre production, comprising:
building a carcass structure;
building a crown structure;
coupling the crown structure with the carcass structure;
   wherein building of the crown structure comprises:
forming at least one belt layer on an auxiliary drum for at least partly manufacturing a belt structure;
turning up the axially opposite side flaps of said at least one belt layer formed on the auxiliary drum;
transferring the belt structure from the auxiliary drum to at least one service drum;
forming a tread band by winding up at least one continuous elongated element of elastomeric material, through formation of coils disposed mutually side by side around the belt structure carried by the service drum.

Thus the Applicant thinks it possible to reconcile the requirement of carrying out particular operations requested in manufacturing the crown structure for the purpose of achieving excellent qualitative standards and maximum repeatability of results in the final product, with the requirement of obtaining high exploitation of the equipment and efficient reduction in the down time during processing, to the benefit of the production efficiency. In particular, execution of the turning-up operations on at least one of the belt layers and the spiralling operations for obtaining the tread band, enables achievement of excellent qualitative features in the final product, particularly appreciated in tyres for ultra high performance sports races, without productivity being impaired.

In accordance with a second aspect, the invention relates to a plant for tyre production, comprising:
a building line for carcass structures;
a building line for crown structures;
an assembling location in which each crown structure is coupled with one of the carcass structures;
   wherein said building line for crown structures comprises:
at least one auxiliary drum;
at least one service drum;
devices for forming a belt structure on said auxiliary drum, said devices comprising members for forming at least one belt layer and members for turning up axially opposite side flaps of said at least one belt layer;
transfer devices for transferring a belt structure at least partly formed on the auxiliary drum to said at least one service drum;
devices for forming a tread band by winding at least one continuous elongated element of elastomeric material, through formation of coils disposed in mutual side by side relationship around the belt structure carried by the service drum.

The present invention, in accordance with at least one of the above aspects, can have one or more of the preferred features hereinafter described.

The action of forming, on said auxiliary drum, the belt structure of at least one first tyre being processed can be at least partly carried out simultaneously with the action of forming the tread band of at least one second tyre being processed, on said at least one service drum.

The action of coupling the crown structure to the carcass structure is preferably carried out following the same operating rate as followed by the actions of forming the tread band and forming the belt structure.

To the aims of the present specification, the term “operating rate” is understood as indicating the inverse of the time intervening between starting of a processing operation at a given location, the assembling location for example or other work location, and starting of a new processing operation aiming at building an immediately following tyre, in the same work location. For example, if said time is 60 s, the operating rate will be 1/60 Hz.

Building of the crown structures belonging to respective tyres being processed can be simultaneously carried out on respective service drums.

Thus it is possible to further reduce the time cycle, for example for carrying out spiralling intended for completing the belt structure and/or obtaining the tread band, thereby further increasing the operating flexibility of the process. In particular, it is possible to increase accuracy in carrying out spiralling, by limiting the linear deposition speed of the continuous elongated element for example, so as to ensure more geometric accuracy in the deposition and eliminating the risk of inclusion of air bubbles between the coils formed with the continuous elongated element, without impairing productivity.

The action of forming the tread band of the first tyre being processed and the action of forming the tread band of the second tyre being processed are at least partly carried out simultaneously with the manufacture of the belt structure of a further tyre being processed.

A new belt structure will be already available for making the tread band, as soon as processing for manufacturing the tread band on the previous tyre has been completed.

During formation of the tread band, said at least one service drum is preferably driven in rotation and moved by at least one robotized arm in front of a dispensing member supplying said continuous elongated element of elastomeric material.

Movement of the service drum by a robotized arm preferably of the anthropomorphic type, simplifies the spiralling operation.

Also carried out can be the action of positioning and supporting said at least one service drum by at least one robotized arm during the action of transferring the belt structure from the auxiliary drum to said at least one service drum.

The high operating flexibility typical of the preferably anthropomorphic robotized arm reduces the operating constraints in positioning the different work locations. In fact, transfer of the service drum for interaction with other work locations, before and/or after carrying out spiralling, can be achieved quickly and with high flexibility of the geometric positioning. In addition, the same robotized arm as used for supporting the service drum during the spiralling operations can be advantageously employed for the transfer operations.

Preferably, the action of forming said at least one belt layer comprises:
circumferentially winding at least one manufactured article in the form of a strip of elastomeric material including textile cords, around the auxiliary drum;
mutually joining the opposite ends of the manufactured article in the form of a strip.

Use of such a manufactured or semifinished article ensures optimal structural homogeneity of the belt layers, which is particularly appreciated in tyres designed to provide very high performances in sports competitions.

Building of the crown structure can further comprise the action of circumferentially winding a pair of ribbon-like reinforcing inserts, each of them being radially superposed on an end edge of one of the turned-up side flaps of said at least one belt layer.

The turned-up end edges are in this way conveniently protected, the undesired contact with other parts of the tyre during use thereof being avoided.

Building of the crown structure can further comprise the action of circumferentially winding up at least one reinforcing element of elastomeric material longitudinally incorporating at least one continuous cord, in the form of coils disposed in axial side by side relationship around said at least one belt layer.

Thus an additional belt layer is formed which is usually referred to as “zero-degree layer” in compliance with the orientation of the reinforcing cords relative to a circumferential direction, which is useful for maintaining a desired cross-section profile of the tyre, even under the effect of high centrifugal forces triggered during use.

Winding of said reinforcing element can be carried out on the belt structure transferred onto the service drum.

It is thus possible to balance the work time for the operations carried out on the auxiliary drum and the service drum, respectively. In addition, formation of the zero-degree layer on the service drum allows the belt structure to be shaped, in case of need, according to a curvilinear cross-section profile using a service drum having a convex-profile outer surface.

Preferably, the action of transferring the belt structure from the auxiliary drum to said at least one service drum comprises the actions of:
removing the belt structure from the auxiliary drum by a first transfer member;
engaging the belt structure on the service drum by the first transfer member.

Removal of the belt structure from the auxiliary drum comprises the actions of:
axially inserting the auxiliary drum carrying the belt structure into the first transfer member;
engaging the belt structure with the first transfer member;
radially contracting the auxiliary drum for disengaging it from the belt structure;
translating the auxiliary drum in an axial direction relative to the first transfer member for removing the auxiliary drum from the belt structure.

Preferably, the action of engaging the belt structure on the service drum comprises:
axially inserting the service drum into the first transfer member carrying the belt structure;
radially expanding the service drum so as to engage it with the belt structure;
disengaging the first transfer member from the belt structure;
axially translating the service drum carrying the belt structure for removing the service drum carrying the belt structure from the first transfer member.

Preferably, the first transfer member keeps a stationary positioning during transfer of the belt structure.

The first transfer member can therefore have a very simple structure, the axial movements being fully carried out by the auxiliary drum and the service drum. In this regard, it is possible to utilise the axial mobility already required from the service drum for dispensing the continuous elongated element during formation of the tread band, and from the auxiliary drum for its movement between different work locations provided for manufacture of the belt structure.

Coupling of the crown structure with the carcass structure preferably comprises the action of transferring the crown structure from the service drum to a primary drum carrying the carcass structure.

Preferably, the action of transferring the crown structure from the service drum to the primary drum comprises the actions of:
removing the crown structure from the service drum by a second transfer member;
engaging the crown structure on the primary drum by means of the second transfer member.

Also carried out can be the action of positioning and supporting the service drum by a robotized arm during the action of transferring the crown structure from the service drum to the primary drum.

The same, preferably anthropomorphic, robotized arm used for supporting the service drum during the spiralling operations can be advantageously used for the operations of transferring the crown structure to the second transfer member.

The action of removing the crown structure from the service drum preferably comprises:
axially inserting the service drum carrying the crown structure into the second transfer member;
engaging the crown structure with the second transfer member;
radially contracting the service drum so as to disengage it from the crown structure.

If the axial movements rely on the service drum, it is possible to simplify the structure and operating bulkiness of the second transfer member. In this regard, the axial mobility already requested from the service drum for distributing the continuous elongated element during formation of the tread band can be utilised.

Preferably, the belt-structure forming device, and the tread-band forming devices, operate simultaneously with each other, on the belt structure and the tread band respectively, of respective tyres being processed.

The belt-structure forming devices and the tread-band forming devices can operate simultaneously with manufacture of at least one carcass structure in the carcass-structure building line.

Preferably, the crown-structure building line comprises:
a first work area in which said at least one auxiliary drum is operatively disposed;
a second work area in which said at least one service drum is operatively disposed, and
a first transfer location in which said transfer devices operate.

The tread-forming devices may comprise members for forming a first portion of the tread band and members for forming a second portion of the tread band operating simultaneously with said belt-forming devices.

Use of at least one robotized arm is preferably provided for driving in rotation and moving said at least one service drum in front of at least one dispensing member of said at least one continuous elongated element of elastomeric material.

In addition or alternatively, at least one robotized arm can be provided for supporting the service drum during actuation of the transfer devices.

The members for forming at least one belt layer preferably comprise a feeding unit for supplying at least one manufactured article in the form of a strip of elastomeric material comprising textile cords, to a first work location designed to wind up said at least one manufactured article around the auxiliary drum.

The belt-forming devices can further comprise a feeding unit for supplying a pair of ribbon-like reinforcing inserts to a second work location designed to wind up said ribbon-like reinforcing inserts around said at least one belt layer.

The belt-forming devices preferably comprise a carriage carrying the auxiliary drum and movable for selectively positioning said auxiliary drum in front of at least one first work location and one second work location.

Preferably, the carriage is movable in parallel to a geometric rotation axis of the auxiliary drum.

The members for turning up the axially opposite side flaps of said at least one belt layer are preferably at least partly integrated into said auxiliary drum.

The crown-structure building line can further comprise winding devices for circumferentially winding at least one reinforcing element of elastomeric material into coils disposed axially side by side around said at least one belt layer, which reinforcing element longitudinally incorporates at least one continuous cord.

The winding devices operate on the belt structure carried by the service drum in a third work location.

More particularly, said at least one service drum can be interlocked with at least one third and one fourth work locations.

In a possible embodiment, provision is made for at least one first service drum and one second service drum simultaneously operating each at one of said third and fourth work locations.

The service drum can have an outer surface shaped into a curvilinear cross-section profile.

Preferably, the transfer devices comprise a first transfer member to be alternately positioned around the auxiliary drum and around the service drum.

The first transfer member preferably comprises radially movable elements for selectively engaging and releasing the belt structure.

The auxiliary drum is preferably movable along a geometric rotation axis thereof for being coaxially fitted into the first transfer member.

The auxiliary drum can be radially contractible for disengaging the belt structure engaged by the first transfer member.

The service drum can be movable along a geometric rotation axis thereof for being coaxially fitted into the first transfer member.

The service drum can be radially expandable for engaging the belt structure carried by the first transfer member.

The first transfer member is preferably substantially fixed in said crown-structure building line.

The carcass-structure building line can comprises a primary drum having halves axially movable close to each other for determining radial expansion of the carcass structure.

Preferably, provision is made for a second transfer location including at least one second transfer member that can be alternately positioned around the service drum and around a primary drum operating in the carcass-structure building line.

The service drum is preferably movable along a geometric rotation axis thereof for being coaxially fitted into the second transfer member.

The second transfer member is preferably movable along a geometric rotation axis of the primary drum for positioning the crown structure coaxially around the primary drum.

The service drum can be radially contractible for disengaging the crown structure in engagement with the second transfer member.

Preferably, the robotized arm is an anthropomorphic robotized arm.

Further features and advantages will become more apparent from the detailed description of a preferred but not exclusive embodiment of a process and a plant for building tyres in accordance with the present invention.

This description will be set out hereinafter with reference to the accompanying drawings, given by way of non-limiting example, in which:

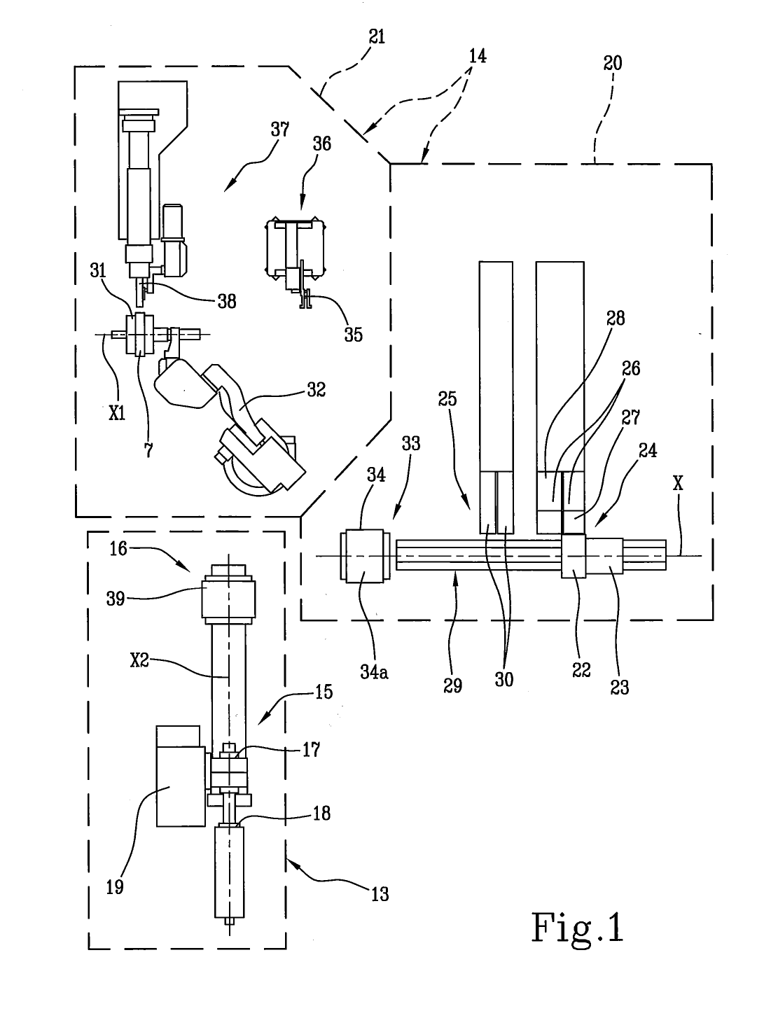

FIG. 1 diagrammatically shows a top view of a plant for building tyres carried out in accordance with a preferred example of the present invention;

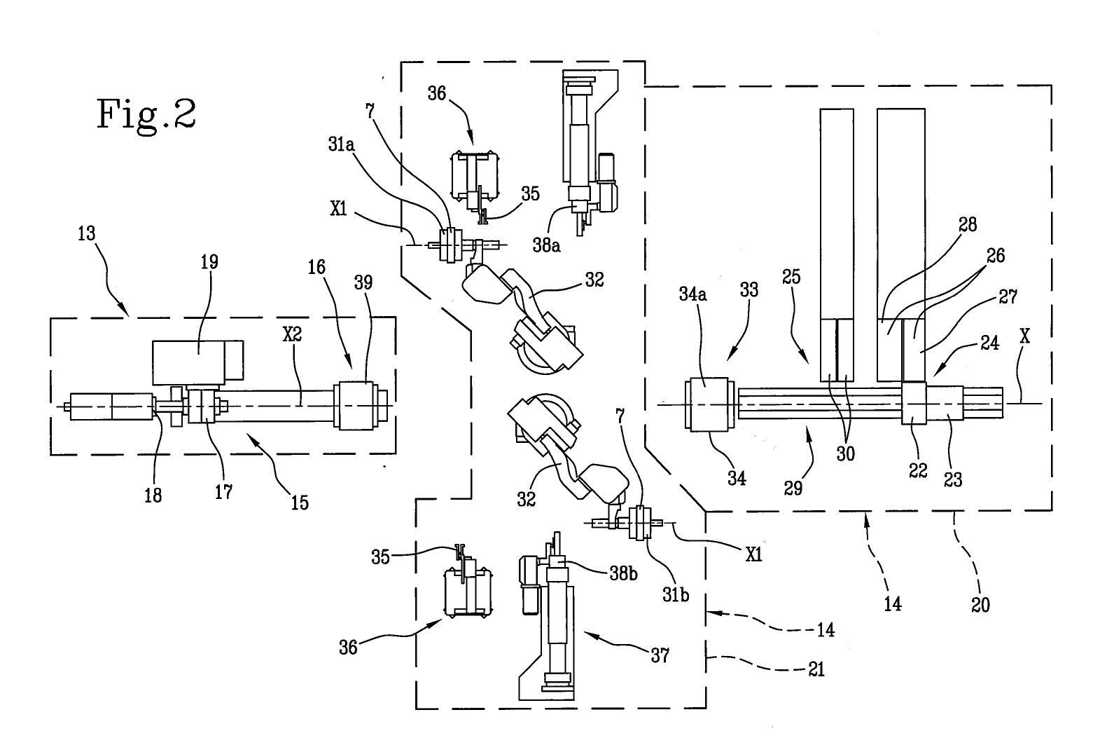

FIG. 2 diagrammatically shows a top view of a plant for building tyres carried out in accordance with a possible preferred variant of the present invention;

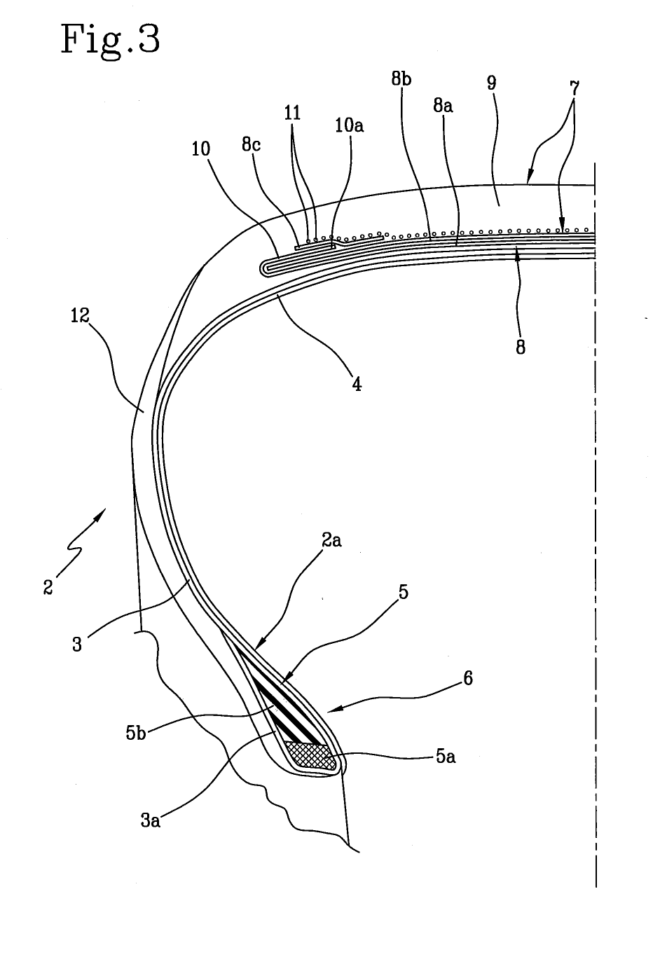

FIG. 3 shows a cross section of a tyre obtainable according to the present invention.

With reference to the mentioned figures, a plant for building tyres for vehicle wheels intended for putting into practice a process according to the present invention has been generally identified with reference numeral 1.

Plant 1 is designed for building tyres 2 (FIG. 3) essentially comprising a carcass structure 2a having at least one or several carcass plies 3. For simplicity of exposition, in the following reference will be made, just by way of example, to the presence of only one carcass ply 3, being understood that if necessary two or more carcass plies will be provided, depending on requirements.

A layer of airtight elastomeric material or so-called “liner” 4 can be applied internally of the carcass ply 3. Two annular anchoring structures 5, each including a so-called bead core 5a carrying an elastomeric filler 5b at a radially external position, are in engagement with respective end flaps 3a of the carcass ply 3.

The annular anchoring structures 5 are integrated in the vicinity of regions usually identified with the name of “beads” 6, where usually engagement between tyre 2 and a respective mounting rim occurs.

A crown structure 7 is circumferentially applied around the carcass structure 3. The crown structure 7 comprises a belt structure 8 having one or more belt layers 8a, 8b and preferably a tread band 9 circumferentially overlapping the belt structure 8.

More particularly, in the example shown provision is made for a first radially-internal belt layer 8a, and at least one second radially-external belt layer 8b.

At least one belt layer, in the example shown the first belt layer 8a, will have axially opposite side flaps 10 turned up at a radially external position on the second radially-outermost belt layer 8b. In the absence of the radially external belt layer or layers 8b, the side flaps 10 of the first belt layer 8a can be turned up upon the first belt layer itself.

The belt structure 8 can further comprise a pair of ribbon-like reinforcing inserts 8c, each of them radially overlapping an end edge 10a of one of the turned-up side flaps 10.

Furthermore, at least one so-called zero-degree layer 11 can be radially superposed on the belt layers 8a, 8b and on possible ribbon-like reinforcing inserts 8c to give the belt structure 8 a predetermined resistance to circumferential and radial extensibility.

Two sidewalls 12, each extending from the corresponding bead 6 to a corresponding side edge of the tread band 9, are applied at laterally opposite positions to the carcass ply 3.

Plant 1 preferably comprises a carcass-structure building line 13, where the carcass structures 2a of the tyres being processed are formed.

The crown structures 7 are built in a crown-structure building line, identified as a whole with 14 in FIG. 1.

At an assembling location 15, coupling of each carcass structure 2a with a respective crown structure 7 is carried out. More particularly, in the example shown the assembling location 15 is operatively integrated into the carcass-structure building line 13.

According to an embodiment shown in FIGS. 1 and 2, the carcass-structure building line 13 comprises at least one primary drum 17, on which the carcass structure 2a of tyre 2 is built. The primary drum 17 can be operatively supported by a chuck 18 or another device enabling it, if necessary, to be driven in rotation and/or suitably moved between one or more work units 19 during application of the components of the carcass structure 2a.

More specifically, the primary drum 17 is adapted to first receive liner 4, if any, and subsequently the carcass ply 3, so as to form a cylindrical sleeve on the axially opposite side flaps 3a of which the annular anchoring structures 5 will be subsequently fitted. Afterwards, turning-up of the sides flaps 3a of the carcass ply 3 around the annular anchoring structures 5 can be carried out. Application of at least one portion of the sidewalls 12 on the primary drum 17 can be also provided, as well as application of at least one abrasion-proof element, depending on the construction process.

In the above described manufacturing form, the primary drum 17 is of the type adapted to carry out building of tyre 2 following a so-called “unistage process”, in which coupling between the crown structure 7 and carcass structure 2a does not require transfer of the carcass structure 2a from said primary drum 17 on which it was built to another drum, since in the primary drum 17 halves that are axially movable towards each other are provided for determining radial expansion of the carcass structure 2a, to couple the latter with the crown structure 7.

In a further preferred embodiment the primary drum 17 can be a second-stage drum or a so-called “shaping drum” on which a carcass structure 2a build somewhere else, for example although not necessarily in said carcass-structure building line, is initially fitted, while subsequently a corresponding belt structure 7 is brought to a position radially external to said drum and duly centred on the already present carcass structure 2a. This type of primary drum 17 too is provided with halves that are axially movable towards each other to determine radial expansion of the carcass structure 2a, to couple it with the crown structure 7.

In both the described cases said assembling location 15 is therefore coincident with the primary drum 17 location.

In the crown-structure building line 14 at least one first work area 20 and at least one second work area 21 can preferably be identified. At the first work area 20 belt-structure forming devices 26 operate for building a belt structure 8 or at least a first part thereof, on at least one auxiliary drum 22.

The auxiliary drum 22 can be rotatably supported by a carriage 23 that is movable preferably in parallel to a geometric rotation axis X of the auxiliary drum, for selectively positioning the latter in front of at least one first work location 24 and one second work location 25 spaced apart from each other.

The belt-structure forming devices 26 preferably comprise members designed to form at least the first belt layer 8a, by means of a first feeding unit 27 for example, operating at the first work location 24 for dispensing at least one first manufactured article in the form of a strip of elastomeric material including textile cords disposed parallelly adjacent to each other and oriented according to a predetermined angle, preferably included between about 30° and about 60°, relative to the longitudinal extension of the manufactured article itself. The first manufactured article dispensed by the first feeding unit 27 is applied around the auxiliary drum 22, driven in rotation so as to form the first belt layer 8a wound up a full turn around the auxiliary drum 22 itself. At the end of winding, the first manufactured article is transversely cut in the vicinity of the auxiliary drum 22 and the ends of the first belt layer 8a thus formed are mutually joined end-to-end.

Also provided can be a second feeding unit 28 for dispensing a second manufactured article in the form of a strip of elastomeric material preferably having width equal to or smaller than that of the first manufactured article. The second manufactured article may comprise textile or metallic cords disposed parallelly adjacent to each other and oriented according to a predetermined angle, preferably included between about 30° and about 60° relative to the longitudinal extension of the manufactured article, and having crossed orientation relative to the cords of the first manufactured article.

The second manufactured article is preferably applied around the first belt layer 8a in the same manner as said first belt layer, so as to form the second belt layer 8b wound up a full turn around the auxiliary drum 22. At the end of winding, the second manufactured article is transversely cut in the vicinity of the auxiliary drum 22, and the ends of the second belt layer 22 thus formed are mutually joined end-to-end.

The second feeding unit 28 can be operatively installed in the same first work location 24 carrying the first feeding unit 27, or in a distinct work location. In the last-mentioned case, intervention of the second feeding unit 28 will take place after actuation of carriage 23, to remove the auxiliary drum 22 from the first work location and bring it to the location carrying the second feeding unit 28.

When deposition of the belt layers 8a, 8b has been completed, the axially opposite side flaps 10 of said at least one first belt layer 8a, preferably axially projecting beyond the respective end edges of the second belt layer 8b, are turned up in such a manner that they are radially superposed externally of the second belt layer itself. This operation can be carried out by suitable turning-up members not described or shown in detail as they are obtainable in a manner known by itself, with the aid for example of inflatable and/or suitably deformable bags upon command of mechanical thrust elements partly or fully integrated into the auxiliary drum 22 itself.

The turning-up operation can be carried out after displacement of carriage 23 for positioning the auxiliary drum 22 to a turning-up location 29 laterally spaced apart from the first work location 24 at which winding up of the first belt layer 8a and/or the second belt layer 8b occurs, so as to avoid mechanical interference between the members intended for formation of the belt layer or layers 8a, 8b and the above mentioned turning-up members.

At the first work area 20 a third feeding unit 30 can be also operatively arranged for supply of the pair of ribbon-like reinforcing inserts 8c, each made in the form of a strip of elastomeric material having axial size preferably smaller that half the axial size of the belt layers 8a, 8b when turning-up has been completed. Each ribbon-like reinforcing insert 8c incorporates preferably textile cords, nylon cords for example, extending longitudinally. The third feeding unit 30 preferably operates in said second work location 25, designed to wind up the ribbon-like reinforcing inserts 8c around the previously formed belt layer or layers 8a, 8b. The second work location is reached by the auxiliary drum 22 following movement of carriage 23, after the turning-up step. The ribbon-like reinforcing inserts 8c can be distributed simultaneously close to the turned-up side flaps 10 of the belt layer or layers 8a, 8b, while the auxiliary drum 22 is being driven in rotation for determining winding of said inserts in a full turn. At the end of winding, each of the ribbon-like reinforcing inserts 8c is transversely cut in the vicinity of the auxiliary drum 22 and joined end-to-end at the respective ends.

When processing in the first work area 20 has been completed, building of the crown structure 7 goes on in the second work area 21, interlocked with at least one service drum 31, preferably connected to a robotized arm 32, preferably of the anthropomorphic type.

To this aim, the auxiliary drum 22 is preferably brought, by axial displacement of carriage 23 for example, to a first transfer location 33 operatively interposed between the first work area 20 and the second work area 21. In the first transfer location 33 devices 34 operate for transferring the belt structure 8 from the auxiliary drum 22 to the service drum 31.

In a preferred embodiment these transfer devices 34 comprise at least one first transfer member 34a that can be alternately positioned around the auxiliary drum 22 and the service drum 31.

Preferably, the first transfer member 34a is substantially fixed in said crown-structure building line 14 and is adapted to be alternately engaged by the auxiliary drum 22 and the service drum 31.

The auxiliary drum 22 in fact is movable along its geometric rotation axis X upon command of carriage 23, for being coaxially inserted into the first transfer member 34a.

When the auxiliary drum 22 is coaxially inserted, preferably at an axially centred position, in the first transfer member 34a, radially movable elements (not shown) operatively associated with said drum and made in the form of circumferentially consecutive circular sectors for example, carry out engagement of the belt structure 8 or the first part thereof formed on the auxiliary drum 22.

The auxiliary drum 22, made up of radially contractible sectors (not shown) is radially contracted so as to disengage the belt structure 8.

By a backward movement of carriage 23, the auxiliary drum 22 is axially translated relative to the first transfer member 34a and consequently removed from the belt structure 8 that is retained by the first transfer member 34a by means of the radially movable elements at a radially contracted position.

The service drum 31 in turn is adapted to be translated along the geometric rotation axis thereof X1 upon command of the robotized arm 32, to be coaxially inserted into the first transfer member 34a carrying the belt structure 8.

The service drum 31 comprising radially movable sectors (not shown) for example, can be radially expanded so as to engage the belt structure 8.

After expansion of the service drum 31, the radially movable elements of the first transfer member 34a are radially moved apart from the belt structure 8 that will remain in engagement with the service drum 31.

In case of need the service drum 31, at least in the radially expanded condition, can show an outer surface having a curvilinear cross-section profile, so as to impose a desired conformation to the belt structure 8 engaged by the service drum 31.

Through the robotized arm 32 the service drum 31 is then axially translated to be removed from the first transfer member 34a together with the belt structure 8.

The robotized arm 32, of the type having six or more movement axes for example, is able to support, drive in rotation and conveniently move the service drum 31 in the second work area 21 for accomplishment of the tread band 9 and, in case of need, of at least one second part of the belt structure 8.

This second part of the belt structure 8 can for example comprise the aforesaid zero-degree layer 11 that, just as an indication, extends over at least 80% of the axial extension of the belt layer or layers 8a, 8b. The zero-degree layer 11 is applicable in addition to or in place of the ribbon-like reinforcing inserts 8c in the first work area 20, by means of winding devices 35 operating in a third work location 36, preferably installed in the second work area 21. The zero-degree layer 11 is obtained by circumferentially winding up at least one reinforcing element of elastomeric material longitudinally incorporating one or more continuous cords, in the form of coils disposed in side by side relationship around the belt layer or layers 8a, 8b.

The reinforcing element can be supplied by the winding devices 35 to the service drum 31, while the latter is being driven in rotation and conveniently moved by the robotized arm 32 in front of the winding devices 35.

When formation of the zero-degree layer 11, if any, has been completed, the robotized arm 32 brings the service drum 31 close to at least one fourth work location 37 wherein tread-band forming devices 38 operate which for example comprise at least one extruder or other member suitable for carrying out controlled supply of a continuous elongated element of elastomeric material. The auxiliary drum 22 is driven in rotation and suitably moved by the robotized arm 32, so as to determine deposition of the continuous elongated element into mutually adjacent coils around the belt structure 8 carried by the service drum 31, until formation of the tread band 9 having the desired conformation and thickness has been completed.

In case of need, as shown by way of example in FIG. 2, the tread-band forming devices 38 can comprise two or more extruders 38a, 38b or different dispensing members, possibly disposed at respectively distinct work locations, so as to form at least one first and one second portions of the tread band 9 respectively, and/or other tyre components, using different-composition materials.

Also provided can be use of at least one first service drum 31a and one second service drum 31b, similar or different from each other, each interlocked with a respective robotized, preferably anthropomorphic, arm 32a, 32b, for carrying out simultaneous building of crown structures 7 belonging to distinct tyres in the second work area 21.

More particularly, formation of the first portion of the tread band 9 on the first service drum 31a and of the second portion of the tread band 9 on the second service drum 31b can be carried out simultaneously.

In addition or alternatively, formation of the tread band 9 of a first and a second tyre being processed can be simultaneously carried out, on the first service drum 31a and on the second service drum 31b, respectively.

In addition or alternatively, as shown by way of example in FIG. 2, formation of the tread band 9 on the first service drum 31a and of the second part of the belt structure 8, i.e. the zero-degree layer 11, on the second service drum 31b can be simultaneously carried out.

When manufacture of the tread band 9 has been completed, the respective service drum 31, 31a, 31b can be brought in engagement relationship to a second transfer location 16, with the aid of the robotized arm 32.

The second transfer location 16 preferably comprises at least one second transfer member 39 that can be alternately positioned around the service drum 31 and around said primary drum 17, operating in the carcass-structure building line 13.

More particularly, the service drum 31 carrying the crown structure 7 is adapted to be translated along the geometric rotation axis thereof X1, upon command of the robotized arm 31, for being coaxially fitted into the second transfer member 39.

The second transfer member 39 for example comprises radially movable elements (not shown) that are adapted to be radially contracted so as to engage the crown structure 7 carried by the service drum 31 in order to remove it therefrom.

After contraction of the radially movable elements of the second transfer member 39, radial contraction of the service drum 31 is determined. The service drum 31 consequently disengages the crown structure 7 that remains in engagement with the second transfer member 39. At this point the service drum 31 can be axially removed from the second transfer member 39, upon the action of the robotized arm 32 and/or following axial movement of the second transfer member itself.

In fact, the second transfer member 39 is preferably movable along a geometric rotation axis X2 of the primary drum 17, as shown in FIGS. 1 and 2, so as to position the crown structure 7 coaxially around the primary drum 17.

Following mutual approaching of the halves of the primary drum 17, coupling of the crown structure 7 with the carcass structure 2a is determined.

After the radially movable elements integrated into the second transfer member 39 are moved away, said transfer member can be axially disengaged from the crown structure 7 that will remain in engagement with the carcass structure 2a on the primary drum 17.

After possible additional processing operations have been carried out for the purpose of improving adhesion of the crown structure 7 to the carcass structure 2a, and/or application of the sidewalls 12 on the laterally opposite surfaces of the tyre being processed for example, the built tyre 2 can be removed from the primary drum 17 to be submitted to a final vulcanisation process and/or other processing operations provided in the production cycle.

The above described configuration of the plant is of such a nature that the simultaneous building of several tyres 2 is allowed, with the greatest flexibility.

More specifically, provision of the first and second work areas 20, 21 in the crown-structure building line 14 enables simultaneous building of several crown structures 7 to be carried out. In fact, the belt-structure forming devices 26 and tread-band forming devices 38 are adapted to operate simultaneously with each other, so that formation of the belt structure 8 of at least one first tyre in the first work area 20 is at least partly carried out simultaneously with formation of the tread band 9 of at least one second tyre on the respective service drum 31, in the second work area 21.

Should two or more extruders 38a, 38 be provided, as shown in FIG. 2, or other members distinct from each other for respectively forming at least one first and one second portion of the tread band 9, formation of the tread band 9 of the first tyre being processed and formation of the tread band 9 of the second tyre being processed will be at least partly carried out simultaneously with the manufacture of the belt structure 8 of a further tyre being processed in the first work area 20.

Preferably, simultaneously with the processing operation in the crown-structure building line 14, at least one carcass structure 2a is built in the carcass-structure building line 13. Preferably, the carcass structure 2a that is about to be manufactured is intended for coupling with the crown structure 7, or one of the crown structures 7 being processed in the second work area 21.

The devices for coupling the crown structure 7 with the carcass structure 2a, as well as the carcass-structure building line 13 as a whole, preferably operate at the same operating rate as that of the tread-band forming devices 9 in the second work area 21 and as that of the belt-structure forming devices 26 in the first work area 20, so that each tyre being processed can be immediately transferred to the following work location avoiding storage of tyres being processed along the plant building lines.

1-49. (canceled)

50. A process for tyre production, comprising:
building a carcass structure;
building a crown structure; and
coupling the crown structure with the carcass structure,
wherein building of the crown structure comprises:
forming at least one belt layer on an auxiliary drum for at least partly manufacturing a belt structure;
turning up axially opposite side flaps of said at least one belt layer formed on the auxiliary drum;
transferring the belt structure from the auxiliary drum to at least one service drum; and
forming a tread band by winding up at least one continuous elongated element of elastomeric material through formation of coils disposed mutually side by side around the belt structure carried by the service drum.

51. The process as claimed in claim 50, wherein forming, on said auxiliary drum, a belt structure of at least one first tyre being processed, is at least partly carried out simultaneously with forming a tread band of at least one second tyre being processed, on said at least one service drum.

52. The process as claimed in claim 50, wherein coupling the crown structure with the carcass structure is carried out following a same operating rate as followed by forming the tread band and forming the belt structure.

53. The process as claimed in claim 50, comprising simultaneously building of crown structures belonging to respective tyres on respective service drums.

54. The process as claimed in claim 50, wherein forming the tread band of a first tyre being processed and forming the tread band of a second tyre being processed are at least partly carried out simultaneously with manufacture of a belt structure of a further tyre being processed.

55. The process as claimed in claim 50, wherein, during formation of the tread band, said at least one service drum is driven in rotation and moved by at least one robotized arm in front of a dispensing member supplying said continuous elongated element of elastomeric material.

56. The process as claimed in claim 50, further comprising positioning and supporting said at least one service drum by means of at least one robotized arm during transferring the belt structure from the auxiliary drum to said at least one service drum.

57. The process as claimed in claim 50, wherein forming said at least one belt layer comprises:
circumferentially winding at least one manufactured article in a form of a strip of elastomeric material around the auxiliary drum, said strip comprising textile cords; and
mutually joining the opposite ends of the manufactured article in the form of a strip.

58. The process as claimed in claim 50, wherein building of the crown structure further comprises circumferentially winding a pair of ribbon-like reinforcing inserts, each of said pair of ribbon-like reinforcing inserts being radially superposed on an end edge of one of the turned-up side flaps of said at least one belt layer.

59. The process as claimed in claim 50, wherein building of the crown structure further comprises circumferentially winding at least one reinforcing element of elastomeric material longitudinally incorporating at least one continuous cord, into coils disposed in axial side by side relationship around said at least one belt layer.

60. The process as claimed in claim 59, wherein winding of said reinforcing element is carried out on a belt structure transferred onto the service drum.

61. The process as claimed in claim 50, wherein transferring the belt structure from the auxiliary drum to said at least one service drum comprises:
removing the belt structure from the auxiliary drum by a first transfer member; and
engaging the belt structure on the service drum by the first transfer member.

62. The process as claimed in claim 61, wherein removing the belt structure from the auxiliary drum comprises:
axially inserting the auxiliary drum carrying the belt structure into a first transfer member;
engaging the belt structure with the first transfer member;
radially contracting the auxiliary drum for the purpose of disengaging the auxiliary drum from the belt structure; and
translating the auxiliary drum in an axial direction relative to the first transfer member for removing the auxiliary drum from the belt structure.

63. The process as claimed in claim 61, wherein engaging the belt structure on the service drum comprises:
axially inserting the service drum into the first transfer member carrying the belt structure;
radially expanding the service drum so as to engage the service drum with the belt structure;
disengaging the first transfer member from the belt structure; and
axially translating the service drum carrying the belt structure for removing the service drum carrying the belt structure from the first transfer member.

64. The process as claimed in claim 61, wherein the first transfer member keeps a stationary positioning during transfer of the belt structure.

65. The process as claimed in claim 50, wherein coupling the crown structure with the carcass structure comprises transferring the crown structure from the service drum to a primary drum carrying the carcass structure.

66. The process as claimed in claim 65, wherein transferring the crown structure from the service drum to the primary drum comprises:
removing the crown structure from the service drum by a second transfer member; and
engaging the crown structure on the primary drum by the second transfer member.

67. The process as claimed in claim 65, further comprising positioning and supporting the service drum by a robotized arm during transferring the crown structure from the service drum to the primary drum.

68. The process as claimed in claim 66, wherein removing the crown structure from the service drum comprises:
axially inserting the service drum carrying the crown structure into the second transfer member;
engaging the crown structure with the second transfer member; and
radially contracting the service drum so as to disengage the service drum from the crown structure.

69. A plant for tyre production, comprising:
a building line for carcass structures;
a building line for crown structures; and
an assembling location in which each crown structure is coupled with one of the carcass structures,
wherein said building line for crown structures comprises:
at least one auxiliary drum;
at least one service drum;
devices for forming a belt structure on said auxiliary drum, said devices comprising members for forming at least one belt layer and members for turning up axially opposite side flaps of said at least one belt layer;
transfer devices for transferring a belt structure at least partly formed on the auxiliary drum to said at least one service drum; and
devices for forming a tread band by winding at least one continuous elongated element of elastomeric material, through formation of coils disposed in mutual side by side relationship around the belt structure carried by the service drum.

70. The plant as claimed in claim 69, wherein the belt-structure forming devices and the tread-band forming devices operate simultaneously with each other, on a belt structure and a tread band respectively, of respective tyres being processed.

71. The plant as claimed in claim 69, wherein the belt-structure forming devices and the tread-band forming devices operate simultaneously with manufacture of at least one carcass structure in the carcass-structure building line.

72. The plant as claimed in claim 69, wherein said crown-structure building line comprises:
a first work area in which said at least one auxiliary drum is operatively disposed;
a second work area in which said at least one service drum is operatively disposed; and
a first transfer location in which said transfer devices operate.

73. The plant as claimed in claim 69, wherein said tread-band forming devices comprise members for forming a first portion of the tread band and members for forming a second portion of the tread band operating simultaneously with said belt-structure forming devices.

74. The plant as claimed in claim 69, further comprising at least one robotized arm for driving in rotation and moving said at least one service drum in front of at least one dispensing member of said at least one continuous elongated element of elastomeric material.

75. The plant as claimed in claim 69, further comprising at least one robotized arm for supporting the service drum during actuation of the transfer devices.

76. The plant as claimed in claim 69, wherein said members for forming at least one belt layer comprise a feeding unit for supplying at least one manufactured article in the form of a strip of elastomeric material comprising textile cords, to a first work location designed to wind said at least one manufactured article around the auxiliary drum.

77. The plant as claimed in claim 69, wherein said devices for forming a belt structure further comprise a feeding unit for supplying a pair of ribbon-like reinforcing inserts to a second work location designed to wind said ribbon-like reinforcing inserts around said at least one belt layer.

78. The plant as claimed in claim 69, wherein said devices for forming a belt structure comprise a carriage carrying the auxiliary drum and movable for selectively positioning said auxiliary drum in front of at least one first work location and one second work location.

79. The plant as claimed in claim 78, wherein said carriage is movable in parallel with a geometric rotation axis of the auxiliary drum.

80. The plant as claimed in claim 69, wherein said members for turning-up the axially opposite side flaps of said at least one belt layer are at least partly integrated into said auxiliary drum.

81. The plant as claimed in claim 69, wherein said crown-structure building line further comprises winding devices for circumferentially winding at least one reinforcing element of elastomeric material into coils disposed axially side by side around said at least one belt layer, said reinforcing element longitudinally incorporating at least one continuous cord.

82. The plant as claimed in the claim 81, wherein said winding devices operate on the belt structure carried by the service drum in a third work location.

83. The plant as claimed in claim 69, wherein said at least one service drum is interlocked with at least one third and one fourth work locations.

84. The plant as claimed in claim 83, comprising at least one first service drum and one second service drum, said first service drum and said second service drum simultaneously operating at one of said third and fourth work locations.

85. The plant as claimed in claim 69, wherein the service drum has an outer surface shaped into a curvilinear cross-section profile.

86. The plant as claimed in claim 69, wherein said transfer devices comprise a first transfer member capable of being alternately positioned around the auxiliary drum and around the service drum.

87. The plant as claimed in claim 86, wherein the first transfer member comprises radially movable elements for selectively engaging and releasing the belt structure.

88. The plant as claimed in claim 86, wherein the auxiliary drum is movable along a geometric rotation axis thereof and capable of being coaxially fitted into the first transfer member.

89. The plant as claimed in claim 86, wherein the auxiliary drum is radially contractible and capable of disengaging the belt structure engaged by the first transfer member.

90. The plant as claimed in claim 86, wherein the service drum is movable along a geometric rotation axis thereof and is capable of being coaxially fitted into the first transfer member.

91. The plant as claimed in claim 86, wherein the service drum is radially expandable and capable of engaging the belt structure carried by the first transfer member.

92. The plant as claimed in claim 86, wherein the first transfer member is substantially fixed in said crown-structure building line.

93. The plant as claimed in claim 69, wherein said carcass-structure building line comprises a primary drum having halves axially movable close to each other for determining radial expansion of the carcass structure.

94. The plant as claimed in claim 69, comprising a second transfer location comprising at least one second transfer member capable of being alternately positioned around the service drum and around a primary drum operating in the carcass-structure building line.

95. The plant as claimed in claim 94, wherein the service drum is movable along a geometric rotation axis thereof and capable of being coaxially fitted into the second transfer member.

96. The plant as claimed in claim 94, wherein the second transfer member is movable along a geometric rotation axis of the primary drum for positioning the crown structure coaxially around the primary drum.

97. The plant as claimed in claim 94, wherein the service drum is radially contractible and capable of disengaging the crown structure in engagement with the second transfer member.

98. The plant as claimed in claim 74, wherein said robotized arm is an anthropomorphic robotized arm.
